(19) United States
(12) Patent Application Publication
(10) Pub. No.: US 2018/0137528 A1
(43) Pub. Date: May 17, 2018

(54) Method for Selling Products with a Chance for Total Refund

(71) Applicant: Ithzak Belo, Tel Aviv (IL)

(72) Inventor: Ithzak Belo, Tel Aviv (IL)

(21) Appl. No.: 15/870,954

(22) Filed: Jan. 14, 2018

Related U.S. Application Data
(63) Continuation-in-part of application No. 15/345,848, filed on Nov. 8, 2016.

(51) Int. Cl. G06Q 30/02

(52) U.S. Cl. CPC G06Q 30/0212; G06Q 30/0234; G06Q 30/0239

(57) ABSTRACT

A method performed by a processing device running on a server that enables a seller to present on a website a deal for selling products at a certain price, to presents continuously in real time the updated total number of buyers, to states that a person who will buy the product will receive a specific personal number which is equal to the updated total number of buyers plus one, to presents in the website a legal obligation that if in the future the updated total number of buyers will be equal to the specific personal number of the person when doubled by pre-determined number, then the person will be entitled to receives a specific or total refund or a specific sum of money.

### RELATED APPLICATIONS

This application is a continuation in part of U.S. patent application Ser. No. 15/345,848 filed on 8 Nov. 2016.

### TECHNICAL FIELD

The present patent application refers to a method for a marketing deal in which a buyer has the chance to get full refund or even more if and when in the future the total number of buyers will be equal or greater that a pre-determined number that the specific number of that buyer. This method provides a marketing tool to give customers great discount or even total refund without increasing the marketing cost of the seller.

### BACKGROUND ART

There are many known methods for selling products and services that includes incentives to the public to buy those products or services. For the sake of fluency the term “product” in this application and in the claims refers and includes also “services”. For example, the “one plus one” method which means that the buyer may buy two products at the price of one; the “card method” when the buyers receives point per each purchase that may be used as a currency for buying products; a method of “shopping group” when the final price of the product depends on the final amount of buyers; and so on.

U.S. Pat. No. 6,631,356 (hereinafter “Patent 356”) described a method for providing equal discount to all the buyers in a deal, with a promise that as much as the total number of the buyers in the deal will be greater, then the equal discount for each buyer will increase. On the other hand, the method subject matter of the present invention has a different structure. First, the buyer in the deal of Patent cannot receive a total refund, whereas the buyer in the deal of the present invention has the chance to receive a total refund. Second, the total discount that the seller in the deal of Patent 356 may be relatively increase as much as more buyers join the deal, whereas the total discount that the seller in the deal of the present invention remains relatively the same regardless the amount of buyers who joined the deal. The present patent application discloses a method for a deal in which a buyer has the chance to get full refund or even more.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 illustrates an example of the method for purchasing a product.

FIG. 2 illustrates an example of the method for purchasing a gambling ticket.

FIG. 3 illustrates schematically the server (100), the website (200), the product (300), the price (400), the updated total number of buyers (500) and the pre-determined number (600).

FIG. 4 illustrates an example of the method for investments in crowd-funding.

### THE INVENTION

The main object of the present invention is to provide a method performed on a processing device running on a server that enables a seller with the possibility to provide earliest buyers with bigger discount or even full refund. The method includes inter alia the followings: The business owner, who is the seller, creates a deal, which is presented on a web site. The updated number of buyers in the deal are continuously counted and presented in real time in the website. The deal promises, bigger discount if and when the updated number of buyers, will be x times bigger than the customer number, that he has got when he joined the deal as a buyer. The number x may be any number that the seller choose and may be for example a number between the numbers 1 to 1,000,000, and when x is lower the deal is more attractive.

In other words, the method subject matter of the present inventions is in fact a method performed by a processing device running on a server, comprising the following steps: (a) The method enables a seller to present on a website a deal for selling products at a certain price. (b) The method enables to present continuously in real time on the website the updated total number of buyers who already have bought the product in the deal. (c) The seller states in the website that the person who will buy now the product in the deal will receive a specific personal number which is equal to the updated total number of buyers plus one. (d) The seller presents in the website a legal obligation to that person that if and when in the future the updated total number of buyers will be equal to the specific personal number of that person when doubled by pre-determined number, then that person will be entitled to receives a specific or total refund of the price that he pay for the product or even a specific sum of money that may be higher than the price of the product. (e) The seller presents in advanced the pre-determined number in the website, for enabling that person to be aware of the numerical size of that pre-determined number before buying the product in the deal.

The pre-determined number can be any number that the seller may choose. For example, in case when the normal price of the product is $50 USD and normally the seller agrees to sell it at $40 USD, means in a discount of 20%, then the seller may choose the number 5 as the pre-determined number. In this way the total theoretical discount of every 5 persons will be shifted to the first one of them. Thus, creating the hope, that may be fulfilled by time being that that person will receive a total refund. Indeed, that person is aware to the fact that if he will be a buyer number 2 to 5, in that example, he will actually pay the whole price, $50 USD, but he may take the chance that in the future he may be number one and then will receive a total refund, means, the whole or nothing concept. That may increase the incentive in the public to buy the product in that deal.

For example: the seller may present on the website the slogan: “Buy product, cost $50 and get back $50, if the number of buyers in the deal will be 5 times larger than your specific personal number which will be equal to the updated total number of buyers plus one. The method does not increase the total discount that the seller is willing to give. When the seller agrees to give 10 dollars discount to each buyer, then in case of 5 buyers he agrees in fact to give a total discount of $50 UDS but under this method this total discount will be given to that buyer instead of share it between those five buyers.

The purpose of this method subject matter of the present patent application is to create a marketing tool to give to the buyers a possibility to get larger discount or even a refund without increasing the marketing cost.

The method to give bigger discount, of this invention is: a business owner creates a deal, on a website. The updated total number of buyers in the deal is counted continuously and presented to the customers. Each customer who bought the product in the deal receives a specific personal number which is equal to the updated total number of buyers plus one. The deal promises a bigger discount if the total number of buyers in the future, will be x times bigger than the specific personal number. When x is lower the deal is more attractive. The deal may be limited in time or unlimited. When the deal is limited by time then only part of the buyers may get the discount or refund, and when the deal is not limited by time then theoretically many buyers have a good chance to get that discount or refund, as long as more people continuous to buy the product in the deal.

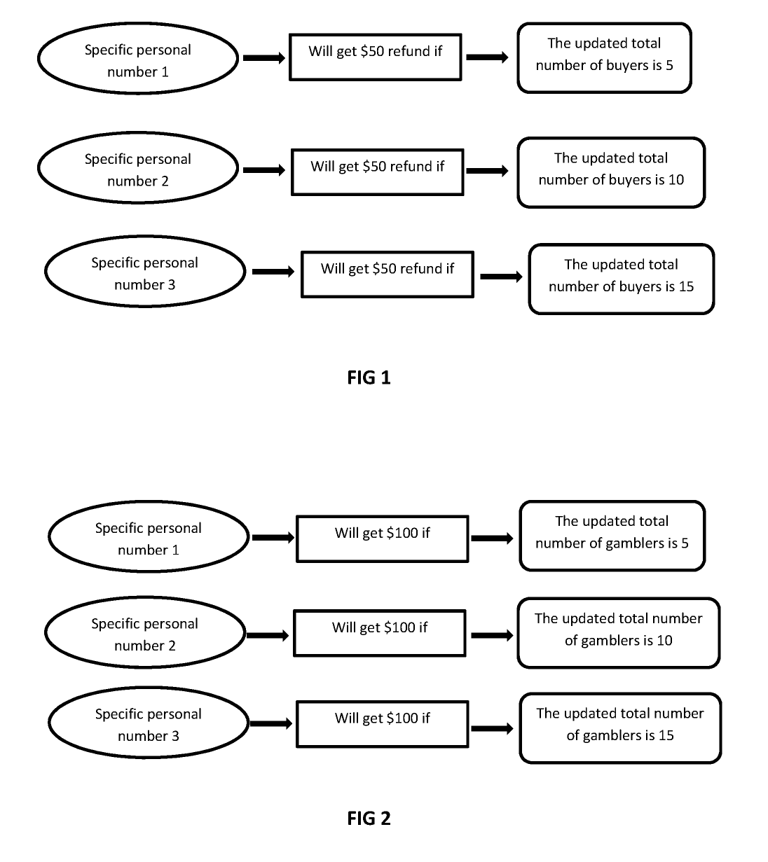

FIG. 1 illustrates an example of the deal when the price of the product is $50 USD and the legal obligation of the seller is to give back that $50 USD to buyer number 1, means the first buyer, if and when the total number of buyers will be five. FIG. 2 illustrates another example for selling a gambling ticket that cost $50 USD and the seller promise to give back the sum of $100 USD to each buyer if and when the updated total number of buyers in the future will be five times bigger that the specific personal number of that buyer. In such case, even that the gambling ticket of the buyer does not win the gambling, he still has the chance to get a full refund plus a win of $50 UDS.

In such case, the seller gives back the sum of $100 USD only to one gambler from that group of five gamblers, means that the seller got $250 and gives back $100 and so he earns 150$ from each group of five gamblers. Gambler number 1 will win 100 $ when will be 5 gamblers. Gambler number 2 will win 100$ when will be 10 gamblers (2×5). gambler number 3 will win 100$ when will be 15 gamblers in this deal (3×5) and so on . . . .

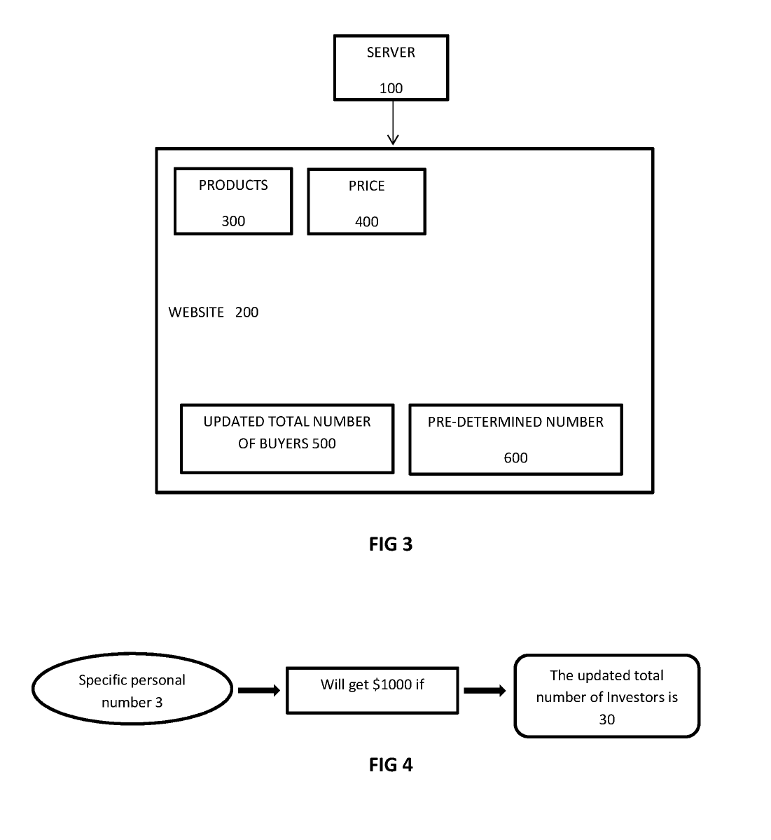

FIG. 3 illustrates schematically the server (100), the website (200), the product (300), the price (400), the updated total number of buyers (500) and the pre-determined number (600).

The concept of the method subject matter of the present invention may be applied also on a crowd-funding, by enabling an entrepreneur to present on a website a deal for investing a certain amount of money in a specific enterprise with obligation for a specific return for each investment; to continuously presents in real time on the website an updated total number of investors who already have invested said certain amount of money in the deal; to states that a person who will invest that certain amount of money in the deal will receive a specific personal number which is equal to the updated total number of investors plus one; to presents in the website a legal obligation to that person that if and when in the future an updated total number of investors in the deal will be equal to the specific personal number of that person when doubled by pre-determined number, then that person will be entitled to receives a specific sum of money beyond the amount of return for each investment, and to present in advanced the pre-determined number in the website, enabling that person to be aware of the numerical size of the pre-determined number before investing in the deal. FIG. 4 illustrates schematically an example that when the investment unit is $1,000 and the pre-determined number is 10, then for example an investor number 3 will receives full refund of $1,000 when the updated total number of investors is 30.

What is claimed is:

1. A method performed by a processing device running on a server, comprising:
(a) enabling a seller to present on a website a deal for selling products at a certain price;
(b) presenting continuously in real time on the website an updated total number of buyers who already have bought the product in the deal;
(c) stating that a person who will buy the product in the deal will receive a specific personal number which is equal to said updated total number of buyers plus one;
(d) presenting in the website a legal obligation to said person that if and when in the future an updated total number of buyers will be equal to the specific personal number of said person when doubled by pre-determined number, then said person will be entitled to receives a specific or total refund of the price or a specific sum of money; and
(e) presenting in advanced said pre-determined number in the website, enabling said person to be aware of the numerical size of said pre-determined number before buying the product in the deal.

2. A method performed by a processing device running on a server, comprising:
(a) enabling an entrepreneur to present on a website a deal for investing a certain amount of money in a specific enterprise with obligation for a specific return for each investment;
(b) presenting continuously in real time on the web site an updated total number of investors who already have invested said certain amount of money in the deal;
(c) stating that a person who will invest said certain amount of money in the deal will receive a specific personal number which is equal to said updated total number of investors plus one;
(d) presenting in the website a legal obligation to said person that if and when in the future an updated total number of investors will be equal to the specific personal number of said person when doubled by pre-determined number, then said person will be entitled to receives a specific sum of money beyond said specific return for each investment; and
(e) presenting in advanced said pre-determined number in the website, enabling said person to be aware of the numerical size of said pre-determined number before investing in the deal.

3. A method performed by a processing device running on a server, comprising:
(a) enabling a seller to present on a website a deal for selling gambling tickets at a certain price;
(b) presenting continuously in real time on the web site an updated total number of buyers who already have bought the gambling ticket in the deal;
(c) stating that a person who will buy the gambling ticket in the deal will receive a specific personal number which is equal to said updated total number of buyers plus one;
(d) presenting in the website a legal obligation to said person that if and when in the future an updated total number of buyers will be equal to the specific personal number of said person when doubled by pre-determined number, then said person will be entitled to receives a specific sum of money; and
(e) presenting in advanced said pre-determined number in the website, enabling said person to be aware of the numerical size of said pre-determined number before buying the gambling ticket in the deal.
